(19) United States
(12) Patent Application Publication
(10) Pub. No.: US 2005/0017927 A1
(43) Pub. Date: Jan. 27, 2005

(54) Plasma display panel and method of driving the same

(75) Inventor: Mitsuhiro Ishizuka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/895,907

(22) Filed: Jul. 22, 2004

(30) Foreign Application Priority Data
Jul. 22, 2003 (JP) 2003-277932

(51) Int. Cl. G09G 3/28

(52) U.S. Cl. 345/60

(57) ABSTRACT

There is provided a method of driving a plasma display panel displaying images in fields each comprised of at least one first-type sub-field having a priming period and at least one second-type sub-field having no priming period, wherein data-writing discharge in the second-type sub-field is generated only when data-writing discharge in the first-type sub-field arranged immediately before the second sub-filed is generated.

### BACKGROUND OF THE INVENTION

1. Field of the Invention

The invention relates to a plasma display panel (PDP) displaying images in fields each comprised of a plurality of sub-fields, a method of driving the plasma display panel, a plasma display unit including the plasma display panel, and a program for causing a computer to carry out the above-mentioned method.

2. Description of the Related Art

In comparison with a conventional cathode ray tube (CRT) or a display unit such as a liquid crystal display unit, a plasma display panel has many advantages that it can be fabricated thinner, it can display images without flickers, it presents a high display contrast, it can be fabricated as a relatively large display screen, it has a higher response speed, it presents superior visibility because it emits lights, and it can display color images by means of three phosphors for converting ultra-violet rays into visible lights of three primary colors, that is, red, green and blue. Hence, a plasma display panel is much used in fields of a computer-related display unit and a color display unit.

A plasma display panel is grouped into an alternating current (AC) type one in which electrodes (such as later-mentioned scanning, sustaining and data electrodes) are covered with a dielectric layer, and which is operated indirectly in AC discharge condition, and a direct current (DC) type one in which electrodes are exposed to a discharge space, and which is operated in DC discharge condition. An alternating current (AC) type plasma display panel is further grouped into a memory operation type one which makes use of a memory function by which sustaining discharge is continued in a cell, and a refresh operation type one which makes no use of the above-mentioned memory function. Herein, a cell means a minimum unit for constituting a display screen. A display screen is comprised of a plurality of cells arranged in a matrix.

In a plasma display panel, a luminance of each of colors displayed in each of cells is in proportion to the number of sustaining pulses. Since the above-mentioned refresh operation type plasma display panel makes no use of the memory function, if a display capacity is increased, a luminance would be reduced. Accordingly, when images are necessary to be displayed with a high luminance and in a large capacity, a memory operation type plasma display panel is used.

Among the above-mentioned AC type plasma display panel, a three-electrode surface-discharge type panel including a pair of row electrodes arranged on a front substrate (first substrate) in parallel with each other, a column electrode arranged on a rear substrate (second substrate) perpendicularly to the row electrodes, and discharge cells arranged at intersections of the row and column electrodes is much used, because highly energized ions generated when surface-discharges are generated at the front substrate do not bombard and hence degrade a phosphor layer formed on the rear substrate, resulting in that a three-electrode surface-discharge type panel could have a long lifetime. Herein, a pair of row electrodes is comprised of a scanning electrode and a sustaining electrode (common electrode), and a column electrode is comprised of a data electrode (address electrode). In a three-electrode surface-discharge type plasma display panel, data and scanning electrodes are driven for generating cross-discharge or data-writing discharge therebetween to thereby select a discharge cell from which a light is emitted, and then, scanning and common electrodes are driven for generating surface-discharge or sustaining-discharge in a selected cell to thereby display desired images.

FIG. 1 is a plan view showing electrode arrangement of a conventional three-electrode surface-discharge AC memory-function type plasma display panel.

The illustrated plasma display panel includes a pair of row electrodes formed on a front substrate, a column electrode formed on a rear substrate, and cells 104 formed at intersections of the row and column electrodes. A pair of row electrodes is comprised of scanning electrodes 101 (S1-Sn) and sustain electrodes (common electrodes) 102 (C1-Cn) both extending in a row direction H in parallel with each other, and a column electrode is comprised of data electrodes (address electrodes) 103 (D1-Dm) extending in a column direction V perpendicularly to the row electrodes. The cells 104 are arranged in a matrix in the row and column directions H and V. Each of the cells 104 includes one scanning electrode 101, one sustaining electrode 102, and one data electrode 103. Accordingly, assuming that the number of the scanning and sustaining electrodes 101 and 102 is “n” and the number of the data electrodes 103 is “m”, the total number of the cells 104 defining a screen of the plasma display panel is “nm”.

When images are displayed in a plasma display panel, it would be impossible to naturally display images only by virtue of two brightness levels accomplished by turning on a cell and turning off a cell. Hence, so-called gray-scale display is carried out by setting brightness levels intermediate between the above-mentioned two brightness levels. Specifically, there are set various brightness levels at which images are displayed at a slightly bright level or a slightly dark level.

One of methods of accomplishing gray-scale display is a sub-field process. In a sub-field process, a field as a period of time for displaying certain image is divided into N sub-fields in each of which cells emit light in a period of time corresponding to a weight of each of bit digits in N-bit pixel data.

It is now assumed that data to be displayed is of 4-bit, in which case, one field F is divided in a sub-field process, as illustrated in FIG. 2, into four sub-fields, specifically, a first sub-field SF1, a second sub-field SF2, a third sub-field SF3 and a fourth sub-field SF4. Weights 1, 2, 4 and 8 are assigned to the first to fourth sub-fields SF1 to SF4, respectively, in accordance with the 4-bit data. Thus, sustaining-discharges are generated once, twice, four times and eight times in the first to fourth sub-fields SF1 to SF4, respectively. As a result, the gray-scale number is sixteen (16) as a sum of 1, 2, 4, 8 and 1 (non-display level).

Since a brightness in the field F is defined as a total of the gray-scale number, the above-mentioned sub-field process would make it possible to display almost natural images.

Each of the first to fourth sub-fields SF1 to SF4 is comprised of a priming period Tp (first period), a priming-eliminating period Tpe (second period), a scanning period Ts (third period), a sustaining period Tc (fourth period), and a sustaining-eliminating period Tce (fifth period).

FIG. 3 is a timing chart showing waveforms of voltages to be applied to the electrodes in one sub-field. A driving pulse is applied to any one of the electrodes in each of the first to fifth periods. Hereinbelow is explained an operation of the plasma display panel illustrated in FIG. 1, with reference to FIG. 3.

In the priming period Tp, priming discharges are generated in all of the cells 104 in order to ensure generation of discharges. In the priming period Tp, a serrate and positive priming pulse Ppr-s is applied to the scanning electrodes S1 to Sn, and a rectangular and negative priming pulse Ppr-c is applied to the sustaining electrodes C1 to Cn. Herein, a positive pulse means a pulse having a voltage higher than a sustaining voltage Vs, and a negative pulse means a pulse having a voltage smaller than the sustaining voltage Vs.

As a result, priming discharge is generated in discharge gas space in the vicinity of a gap formed between each of the scanning electrodes S1 to Sn and each of the sustaining electrodes C1 to Cn in all of the discharge cells. The priming discharge produces active particles which will assist in generation of sustaining discharge in the cells. In addition, negative wall charges are accumulated on the scanning electrodes S1 to Sn, and positive wall charges are accumulated on the sustaining electrodes C1 to Cn.

The priming pulse Ppr-s has a wave-height equal to a priming voltage Vp, and the priming pulse Ppr-c has a wave-height equal to GND. When a voltage difference between the priming pulses Ppr-s and Ppr-c applied to the scanning and sustaining electrodes, respectively, exceeds a threshold voltage, there is generated weak discharge. The priming discharge is comprised of such weak discharges repeatedly generated.

In the priming-eliminating period Tpe, priming-eliminating discharge is generated for reducing wall charges accumulated on the scanning electrodes S1 to Sn and the sustaining electrodes C1 to Cn.

If wall charges having been accumulated on the scanning electrodes S1 to Sn and the sustaining electrodes C1 to Cn in the priming period Tp exist as they are, even in a discharge cell in which data-writing discharge is not generated in the scanning period Ts, sustaining-discharge is generated in the sustaining period Tc. That is, a light is wrongly emitted from a cell or cells. Priming-eliminating discharge is generated in the priming-eliminating period Tpe in order to prevent such wrong emission of light from a non-selected cell or cells.

In the priming-eliminating period Tpe, a serrate and negative priming-eliminating pulse Ppe-s is applied to the scanning electrode S1 to Sn. As a result, weak discharge is generated in all of the cells, and accordingly, the negative wall charges accumulated on the scanning electrode S1 to Sn and the positive wall charges accumulated on the sustaining electrodes C1 to Cn are reduced.

The priming-eliminating pulse Ppe-s has a wave-height equal to a priming-eliminating voltage Vpe.

In the scanning period Ts, data-writing discharge is generated for selecting a cell or cells in which a light is emitted among the plurality of cells 104.

In the scanning period Ts, a negative and rectangular scanning pulse Psc is applied to the scanning electrode S1 to Sn, and a positive and rectangular data pulse Pd is applied to the data electrode 103 to thereby generate data-writing discharge only in cells from which a light should be emitted, with the result of accumulation of electric charges on the scanning electrodes.

The scanning pulse Psc has a wave-height equal to GND, and the data pulse Pd has a wave-height equal to a data voltage Vd. Data-writing discharge is generated only at an intersection of the scanning electrode to which the scanning pulse Psc was applied and the data electrode to which the data pulse Pd was applied.

In the sustaining period Tc, sustaining-discharge is generated for allowing a light to be emitted only from cells in which the data-writing discharge was generated. In the sustaining period Tc, a positive and rectangular sustaining pulse Psus-c is applied to the sustaining electrodes C1 to Cn, and a positive and rectangular sustaining pulse Psus-s is applied to the scanning electrodes S1 to Sn. The sustaining pulse Psus-c has a wave-height equal to a sustaining voltage Vs, and the sustaining pulse Psus-s has a wave-height equal to GND.

Since positive wall charges are accumulated on the scanning electrodes S1 to Sn and negative wall charges are accumulated on the sustaining electrodes C1 to Cn in a cell having been selected in the scanning period Ts, sustaining discharge is generated when a combination voltage of a voltage of the positive sustaining pulse Psus-c and a voltage caused by the wall charges exceeds a threshold voltage. As a result, wall charges accumulated on the sustaining and scanning electrodes such that a voltage caused by the wall charges cancels the voltages applied to the sustaining and scanning electrodes. Accordingly, negative and positive wall charges are accumulated on the sustaining and scanning electrodes, respectively.

Since the positive sustaining pulse Psus-s is then applied to the scanning electrodes, there is generated sustaining discharge when a combination voltage of a voltages of the sustaining pulse Psus-s and a voltage caused by the wall charges exceeds a threshold voltage.

Thereafter, such sustaining voltage is repeatedly generated. A brightness level of the plasma display panel is dependent on the number of sustaining discharges generated in the sustaining period Tc.

In the sustaining-eliminating period Tce, sustaining-eliminating discharge is generated in order to reduce wall charges having been accumulated on the scanning and sustaining electrodes in the sustaining period Tc.

In the sustaining-eliminating period Tce, a negative and serrate sustaining-eliminating pulse Pse-s is applied to the scanning electrodes S1 to Sn, resulting in that the wall charges are reduced. The sustaining-eliminating pulse Pse-s has a wave-height equal to an eliminating voltage Vpe.

One sub-field is carried out in the above-mentioned way, and then, a next sub-field is carried out.

FIG. 4 illustrates an example of gray-scale code which accomplishes sixteen gray-scales by virtue of a combination of the first to fourth sub-fields SF1 to SF4.

For instance, if a gray-scale of twelve (12) is to be accomplished, the third sub-field SF3 having the sustaining-cycle number of 4 and the fourth sub-field SF4 having the sustaining-cycle number of 8 are combined to each other. For instance, if a gray-scale of fifteen (15) is to be accomplished, the first sub-field SF1 having the sustaining-cycle number of 1, the second sub-field SF2 having the sustaining-cycle number of 2, the third sub-field SF3 having the sustaining-cycle number of 4 and the fourth sub-field SF4 having the sustaining-cycle number of 8 are combined to one another.

In the above-mentioned sub-field process, when a certain gray-scale is accomplished by combining the four sub-fields to one another, the priming period Tp is set in all of the first to fourth sub-fields SF1 to SF4 for generating priming discharges in all of the cells. Hence, even if a cell or cells which is(are) turned off in the scanning period Ts and the sustaining period Tc, a light is often slightly emitted from the cell or cells due to the priming discharges. Thus, there is caused a problem that a contrast between a display area in which image is displayed and a non-display area in which image is not displayed in a plasma display panel is reduced.

In order to solve such a problem, there have been suggested solutions in which a priming period is set not in all of sub-fields, but in some of sub-fields to thereby reduce the number of priming discharges for reducing a priming brightness.

For instance, Japanese Patent Application Publication No. 11-296137 has suggested a method of driving a plasma display panel, in which a field is comprised of a plurality of sub-fields. In the suggested method, the number of sub-fields each including a priming period is smaller than the total number of sub-fields, and an order of a sub-field including a priming period is regularly or irregularly varied in each of fields.

Japanese Patent Application Publication No. 11-007264 has suggested a method of driving a plasma display panel, in which a field is comprised of a plurality of sub-fields. In the suggested method, only a top sub-field is designed to include a priming period.

However, the above-mentioned conventional methods are accompanied with a problem that a data voltage may be increased when data-writing discharge is generated in a scanning period, because the number of sub-fields each including a priming period is reduced.

As suggested in the above-mentioned Publications, if the number of sub-fields each including a priming period is reduced, active particles which assist in generation of discharge in a cell are not produced in a sub-field not including a priming period, and thus, wall charges are not accumulated on scanning and sustaining electrodes, resulting in that a data voltage is unavoidably raised when data-writing discharge is generated in a cell.

In particular, when data-writing discharge was generated in an adjacent cell in the previous sub-field, weak discharge is generated in the cell even if data-writing discharge is not generated in the cell, with result of significant reduction of wall charges. Hence, a data voltage necessary for generating data-writing discharge in the cell would be significantly raised in a next sub-field.

FIG. 5 shows such significant increase of a data voltage. Specifically, FIG. 5 shows a relation between a cell arrangement (horizontal axis) and a data voltage (vertical axis).

As is obvious in view of FIG. 5, a data voltage necessary for generating data-writing discharge in a certain cell is relatively small, if data-writing discharge is not generated in a cell located adjacent to the certain cell. In contrast, a data voltage necessary for generating data-writing discharge in a certain cell is raised, if data-writing discharge is generated in a cell located adjacent to the certain cell, that is, if one of cells located adjacent to the certain cell is selected. A data voltage necessary for generating data-writing discharge in a certain cell is further raised, if data-writing discharge is generated in cells located adjacent to the certain cell, that is, if both of cells located adjacent to the certain cell are selected.

If a data voltage is raised, driver ICs mounted in a circuit for driving a plasma display panel are necessary to have enhanced driving ability, resulting increase in costs and power consumption.

### SUMMARY OF THE INVENTION

In view of the above-mentioned problems in the conventional plasma display panels, it is an object of the present invention to provide a plasma display panel which is capable of reducing a priming brightness without an increase in a data voltage, when images are displayed in fields each having both a sub-field including a priming period and a sub-field not including a priming period.

It is also an object of the present invention to provide a method of driving a plasma display panel, which is capable of doing the same.

It is further an object of the present invention to provide a plasma display unit including the above-mentioned plasma display panel.

It is further an object of the present invention to provide a program for causing a computer to carry out the above-mentioned method of driving a plasma display panel.

Hereinbelow are described a plasma display panel, a method of driving a plasma display panel, a plasma display unit including the plasma display panel, and a program for causing a computer to carry out the above-mentioned method all in accordance with the present invention through the use of reference numerals used in later described embodiments. The reference numerals are indicated only for the purpose of clearly showing correspondence between claims and the embodiments. It should be noted that the reference numerals are not allowed to interpret of claims of the present application.

In one aspect of the present invention, there is provided a method of driving a plasma display panel (10) displaying images in fields each comprised of at least one first-type sub-field having a priming period and at least one second-type sub-field having no priming period, wherein data-writing discharge in the second-type sub-field is generated only when data-writing discharge in the first-type sub-field arranged immediately before the second sub-filed is generated.

It is preferable that two gray-scale codes having different combinations of the first and second-type sub-fields are switched alternately for every field.

It is preferable that two gray-scale codes having different combinations of the first and second-type sub-fields are switched alternately for every pixel defining image of a field.

For instance, each of the fields may be comprised of the first, second, first and second-type sub-fields arranged in this order.

For instance, each of the fields may be comprised of one first-type sub-field and at least three second-type sub-fields.

In another aspect of the present invention, there is provided a plasma display panel (10) displaying images in fields each comprised of at least one first-type sub-field having a priming period and at least one second-type sub-field having no priming period, including a first substrate (4), a second substrate (12) facing the first substrate (4), a pair of row electrodes (5, 6) arranged on the first substrate (4) in parallel with each other, a column electrode (13) arranged on the second substrate (12) perpendicularly to the row electrodes (5, 6), cells formed at intersections of the row electrodes (5, 6) and the column electrode (13), and a controller (29) which generates data-writing discharge in the second-type sub-field only when data-writing discharge in the first-type sub-field arranged immediately before the second sub-filed is generated.

It is preferable that the controller (29) alternately switches two gray-scale codes having different combinations of the first and second-type sub-fields for every field.

It is preferable that the controller (29) alternately switches two gray-scale codes having different combinations of the first and second-type sub-fields for every pixel defining image of a field.

For instance, the controller (29) may define each of the fields to be comprised of the first, second, first and second-type sub-fields arranged in this order.

For instance, the controller (29) may define each of the fields to be comprised of one first-type sub-field and at least three second-type sub-fields.

In still another aspect of the present invention, there is provided a plasma display unit including a plasma display panel (10) displaying images in fields each comprised of at least one first-type sub-field having a priming period and at least one second-type sub-field having no priming period, and drivers (21-28) for driving the plasma display panel (10), the plasma display panel (10) including a first substrate (4), a second substrate (12) facing the first substrate (4), pair of row electrodes (5, 6) arranged on the first substrate (4) in parallel with each other, a column electrode (13) arranged on the second substrate (12) perpendicularly to the row electrodes (5, 6), cells formed at intersections of the row electrodes (5, 6) and the column electrode (13), and a controller (29) which generates data-writing discharge in the second-type sub-field only when data-writing discharge in the first-type sub-field arranged immediately before the second sub-filed is generated.

It is preferable that the controller (29) alternately switches two gray-scale codes having different combinations of the first and second-type sub-fields for every field.

It is preferable that the controller (29) alternately switches two gray-scale codes having different combinations of the first and second-type sub-fields for every pixel defining image of a field.

For instance, the controller (29) may define each of the fields to be comprised of the first, second, first and second-type sub-fields arranged in this order.

For instance, the controller (29) may define each of the fields to be comprised of one first-type sub-field and at least three second-type sub-fields.

There is yet another aspect of the present invention, there is provided a program for causing a computer to carry out a method of driving a plasma display panel (10) displaying images in fields each comprised of at least one first-type sub-field having a priming period and at least one second-type sub-field having no priming period, wherein steps executed by the computer in accordance with the program include generating data-writing discharge in the second-type sub-field only when data-writing discharge in the first-type sub-field arranged immediately before the second sub-filed is generated.

The steps may further include alternately switching two gray-scale codes having different combinations of the first and second-type sub-fields for every field.

The steps may further include alternately switching two gray-scale codes having different combinations of the first and second-type sub-fields for every pixel defining image of a field.

The steps may further include defining each of the fields to be comprised of the first, second, first and second-type sub-fields arranged in this order.

The steps may further include defining each of the fields to be comprised of one first-type sub-field and at least three second-type sub-fields.

The advantages obtained by the aforementioned present invention will be described hereinbelow.

In accordance with the present invention, data-writing discharge in the second-type sub-field is generated only when data-writing discharge in the first-type sub-field arranged immediately before the second sub-filed is generated. For instance, it is assumed that a field is comprised of first to fourth sub-fields in this order, and that the second and fourth sub-fields are of the second-type sub-fields, that is, the second and fourth sub-fields do not include a priming period, and the first and third sub-fields are of the first-type sub-fields, that is, the first and third sub-fields include a priming period. In such a case, data-writing discharge in the second and fourth sub-fields is generated only when data-writing discharge in the first and third sub-fields is generated. Thus, it is possible to prevent an increase in a data voltage caused when data-writing discharge is generated in a sub-field having no priming period. Accordingly, it is possible to reduce a priming brightness without an increase in a data voltage, and hence, also possible to prevent reduction in a contrast between a display area and a non-display area in a plasma display panel.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a plan view showing electrode arrangement of a conventional three-electrode surface-discharge AC memory-function type plasma display panel.

FIG. 2 shows a relation between a field and sub-fields.

FIG. 3 is a timing chart showing waveforms of voltages to be applied to electrodes in one sub-field in a conventional plasma display panel.

FIG. 4 illustrates an example of gray-scale code used in a conventional plasma display panel.

FIG. 5 shows a relation between a cell arrangement (horizontal axis) and a data voltage (vertical axis).

FIG. 6 is a perspective view of a cell in a plasma display panel in accordance with the first embodiment of the present invention.

FIG. 7 is a block diagram of a plasma display unit including the plasma display panel in accordance with the first embodiment of the present invention.

FIG. 8 is a timing chart showing waveforms of voltages to be applied to electrodes in one sub-field in the plasma display panel in accordance with the first embodiment of the present invention.

FIG. 9 illustrates an example of gray-scale code used in the plasma display panel in accordance with the first embodiment of the present invention.

FIG. 10A illustrates an example of gray-scale code used in the plasma display panel in accordance with the second embodiment of the present invention.

FIG. 10B illustrates an example of gray-scale code used in the plasma display panel in accordance with the second embodiment of the present invention.

FIG. 11A illustrates an example of gray-scale code used in the plasma display panel in accordance with the third embodiment of the present invention.

FIG. 11B illustrates an example of gray-scale code used in the plasma display panel in accordance with the third embodiment of the present invention.

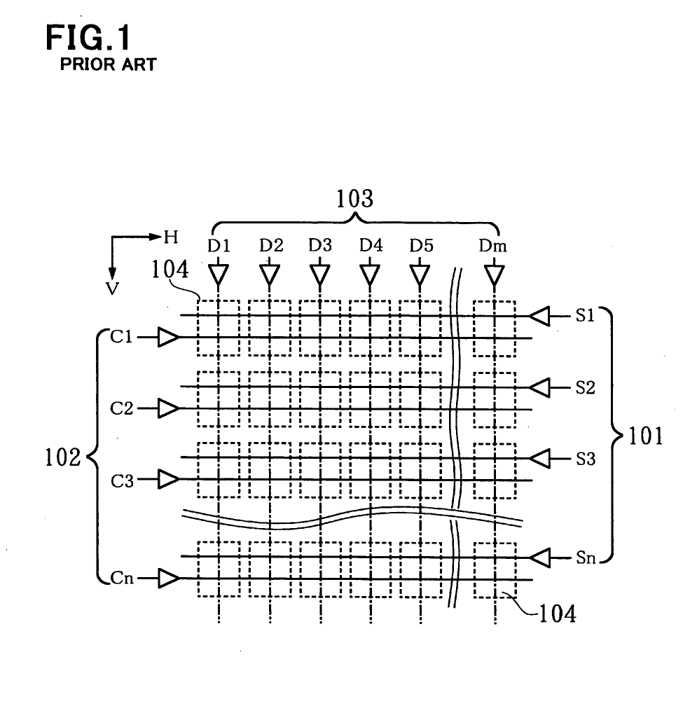

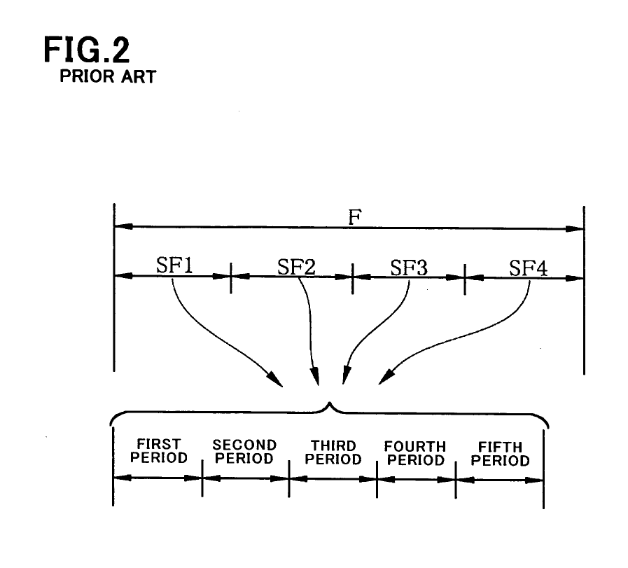

### DESCRIPTION OF THE PREFERRED EMBODIMENTS

Preferred embodiments in accordance with the present invention will be explained hereinbelow with reference to drawings.

### First Embodiment

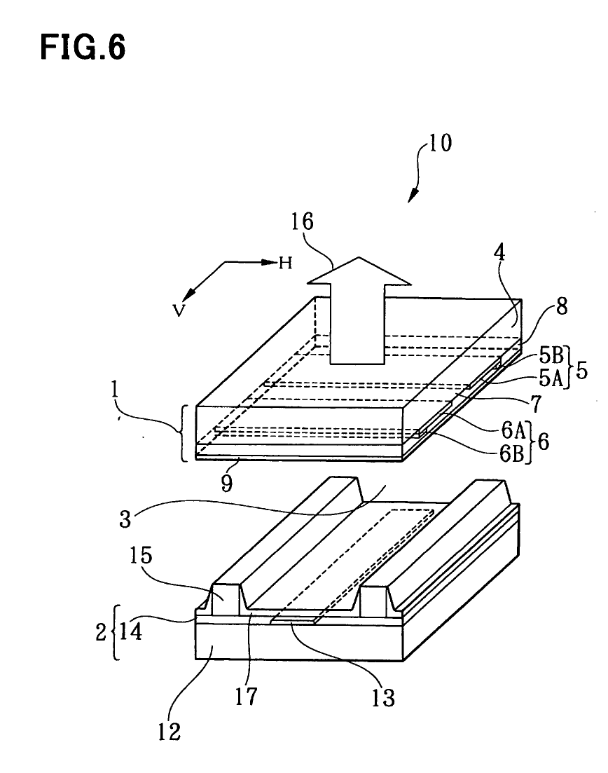

FIG. 6 is a perspective view of a cell in a plasma display panel 10 in accordance with the first embodiment of the present invention.

As illustrated in FIG. 6, the plasma display panel 10 is comprised of a front substrate 1 and a rear substrate 2 in facing relation with each other. A discharge gas space 3 is formed between the front and rear substrates 1 and 2. The discharge gas space 3 is filled with discharge gas such as helium (He), neon (Ne) or xenon (Xe) singly or in combination.

The front substrate 1 is comprised of a first electrically insulating substrate 4, a scanning electrode 5 formed on the first electrically insulating substrate 4, a sustaining electrode (common electrode) 6 formed on the first electrically insulating substrate 4, a dielectric layer 8 composed of frit glass containing lead therein and formed on the first electrically insulating substrate 4 to cover the scanning and sustaining electrodes 5 and 6 therewith, and a protection layer 9 composed of magnesium oxide (MgO) and covering the dielectric layer 8 therewith for protecting the dielectric layer 8 from discharges.

The first electrically insulating substrate 4 is composed of transparent material such as soda lime glass.

The scanning and sustaining electrodes 5 and 6 are formed on the first electrically insulating substrate 4 to extend in a row direction H in parallel with each other, and are spaced away from each other with a discharge gap 7 being formed therebetween. The scanning and sustaining electrodes 5 and 6 define a pair of row electrodes. Each of the scanning and sustaining electrodes 5 and 6 is comprised of a transparent electrode 5A, 6A composed of transparent material such as indium tin oxide (ITO) or tin dioxide (SnO₂), and a bus electrode (trace electrode) 5B, 6B formed partially on the transparent electrode 5A, 6A for reducing electrical resistance. The bus electrode 5B, 6B is composed of metal such as aluminum (Al), copper (Cu) or silver (Ag).

The rear substrate 2 is comprised of a second electrically insulating substrate 12, a data electrode (address electrode) 13 formed on the second electrically insulating substrate 12 to extend in a column direction V perpendicular to the row direction H, a dielectric layer 14 composed of frit glass containing lead therein and formed on the second electrically insulating substrate 12 to cover the data electrode 13 therewith, partition walls 15 defining the discharge gas space 3 and extending in the column direction V to partition discharge cells, and phosphor layers 17 covering an exposed area of the dielectric layer 14 and sidewalls of the partition walls 15 therewith.

The second electrically insulating substrate 12 is composed of transparent material such as soda lime glass.

The data electrode 13 is composed of metal such as aluminum (Al), copper (Cu) or silver (Ag).

The partition walls 15 are composed of frit glass containing lead therein, for instance.

The phosphor layers 17 convert ultra-violet rays generated by discharges of discharge gas, into visible light 16. The phosphor layers 17 are comprised of a red phosphor layer, a green phosphor layer and a blue phosphor layer.

A plurality of such cells as illustrated in FIG. 6 is arranged in a matrix in directions H and V to thereby define the plasma display panel 10.

The front and rear substrates 1 and 2 are fixed such that they face each other with a gap of about 100 micrometers being formed therebetween, and are hermetically sealed with an adhesive at their edges.

The second electrically insulating substrate 12 is formed with a through-hole. Though not illustrated in FIG. 6, a tube is connected to the second electrically insulating substrate 12 at an outer surface thereof in hermetically sealed condition in alignment with the through-hole. The tube is open at an end opposite to an end at which the tube is connected to the second electrically insulating substrate 12. The tube is connected at the open end to an evacuating and gas-filling apparatus.

First, the discharge gas space 3 is evacuated by the evacuating and gas-filling apparatus, and then, discharge gas is introduced into the discharge gas space 3 through the tube from the evacuating and gas-filling apparatus. Thereafter, the tube is heated until melted, to thereby clog the open end. Thus, the discharge gas space 3 is filled with discharge gas.

Thus, the plasma display panel 10 is completed. In a plasma display unit including the plasma display panel 10, a pixel is comprised of three cells (red, green and blue cells) for displaying color images, or a pixel is comprised of a single cell for displaying monochrome images.

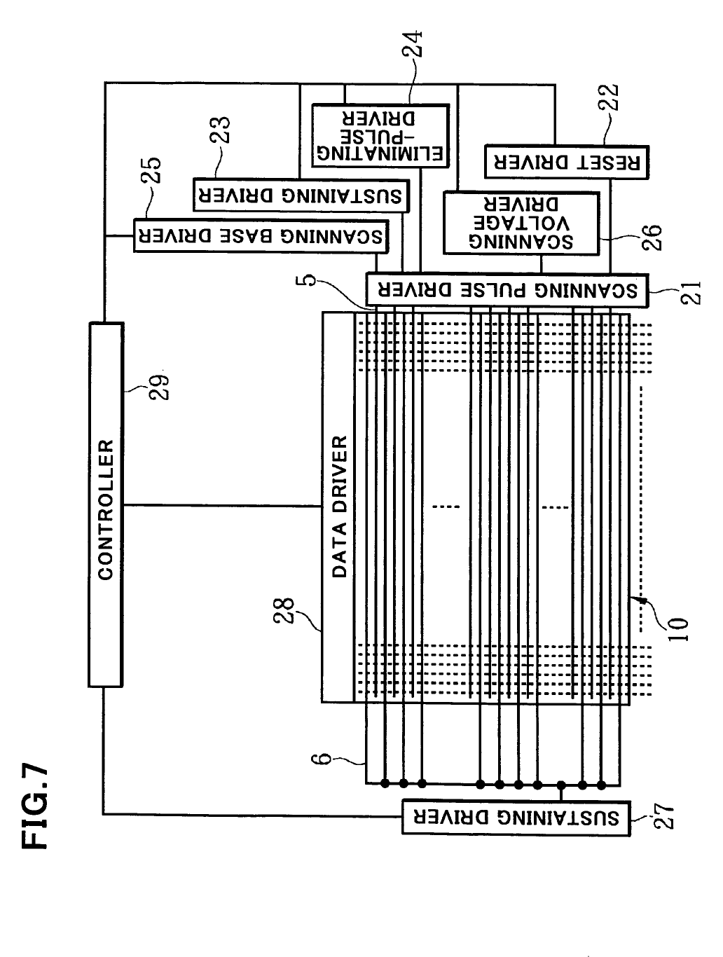

FIG. 7 is a block diagram of a plasma display unit including the plasma display panel 10.

The illustrated plasma display unit is comprised of the plasma display panel 10, a scanning pulse driver 21 outputting a scanning pulse to each of the scanning electrodes 5, a reset driver 22 outputting a reset pulse to all of the scanning electrodes 5, a sustaining driver 23 outputting a sustaining pulse to the scanning pulse driver 21, an eliminating-pulse driver 24 applying an eliminating pulse to the scanning pulse driver 21, a scanning base driver 25 outputting a scanning base pulse to the scanning pulse driver 21, a scanning voltage driver 26 outputting a scanning voltage to the scanning pulse driver 21, a sustaining driver 27 outputting a sustaining pulse to all of the sustaining electrodes 6, a data driver 28 applying a data pulse to the data electrode 13, and a controller 29 controlling an operation of the drivers 22 to 28 in accordance with image signals.

Though not illustrated, the controller 29 is comprised of a central processing unit, a first memory, and a second memory.

Each of the first and second memories is comprised of a semiconductor memory such as a read only memory (ROM), a random access memory (RAM) or an IC memory card, or a storage device such as a flexible disc, a hard disc or an optic magnetic disc. The first memory stores therein a program for driving the drivers 22 to 28. The second memory stores therein various data and parameters. The central processing unit reads the program out of the first memory, and executes the program. Thus, the central processing unit operates in accordance with the program stored in the first memory.

As mentioned later in detail, the controller 29 generates data-writing discharge in a sub-field having no priming period only when data-writing discharge in a sub-field having a priming period and arranged immediately before the sub-filed having no priming period is generated.

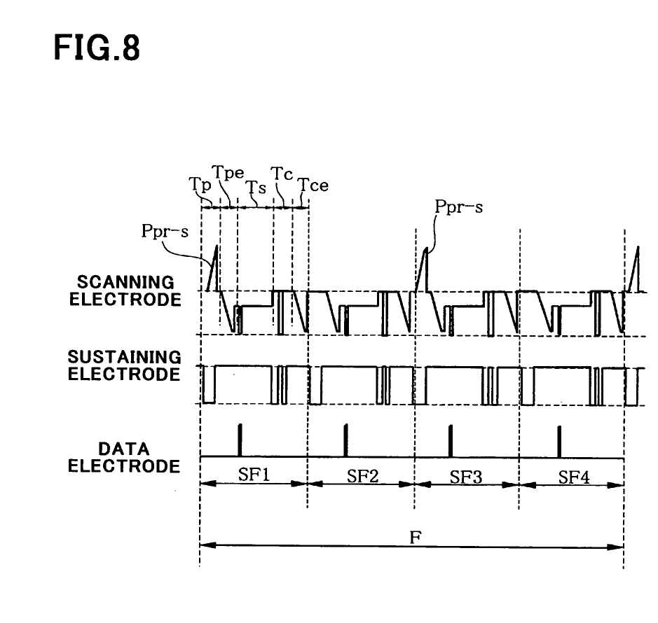

FIG. 8 is a timing chart showing waveforms of voltages to be applied to the electrodes in one sub-field in the plasma display panel 10.

In a process of driving the plasma display panel 10, one field F is comprised of a first sub-field SF1, a second sub-field SF2, a third sub-field SF3 and a fourth sub-field SF4, and the first and third sub-fields SF1 and SF3 are designed to have a priming period Tp (first period), but the second and fourth sub-fields SF2 and SF4 are designed to have no priming period Tp. That is, the priming pulse Ppr-s is not applied to the scanning electrodes 5 in the second and fourth sub-fields SF2 and SF4. Data-writing discharge (that is, address selection) is generated in the scanning period Ts in the second sub-field SF2 having no priming period, only when data-writing discharge (that is, address selection) is generated in the scanning period Ts in the first sub-field SF1 arranged immediately before the second sub-field SF2. Similarly, data-writing discharge (that is, address selection) is generated in the scanning period Ts in the fourth sub-field SF4 having no priming period, only when data-writing discharge (that is, address selection) is generated in the scanning period Ts in the third sub-field SF3 arranged immediately before the fourth sub-field SF4.

Thus, a weight of one (1) is assigned to each of the first and second sub-fields SF1 and SF2, and a weight of three (3) is assigned to each of the third and fourth sub-fields SF3 and SF4.

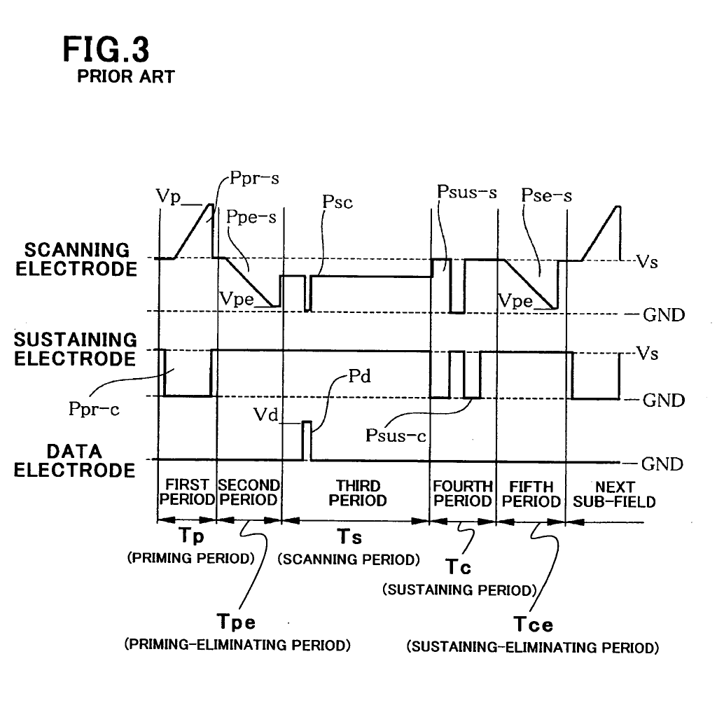

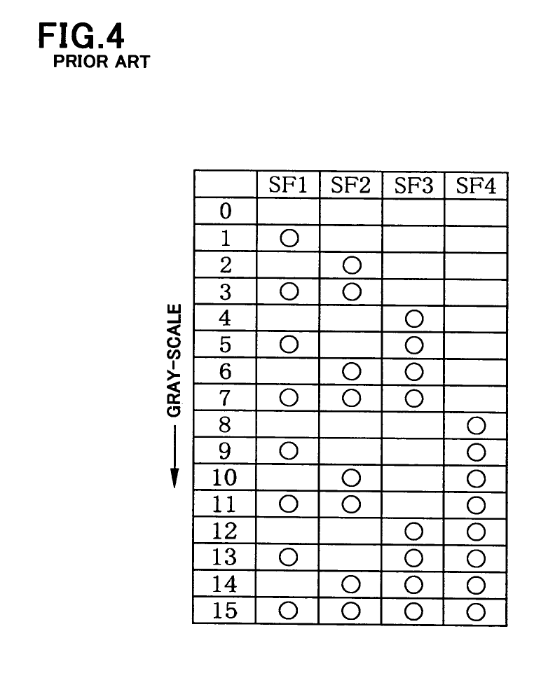

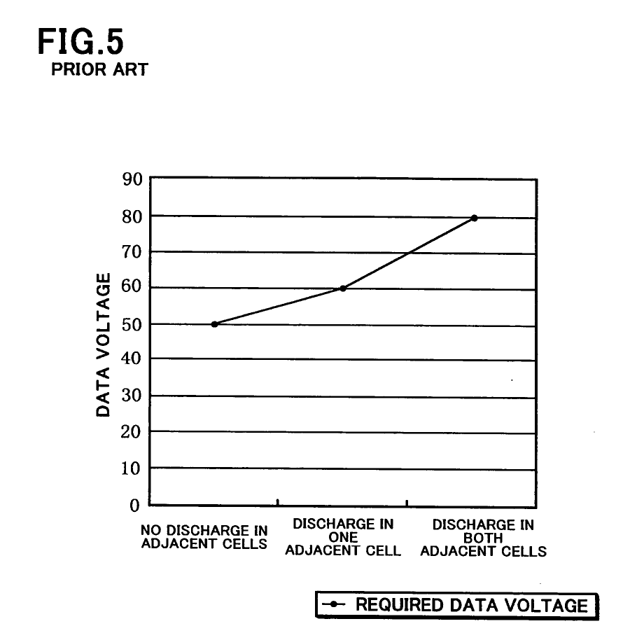

Wave-forms that correspond to those of FIG. 3 have been provided with the same reference numerals, and will not be explained.

In the first embodiment, as mentioned above, the controller 29 drives the plasma display panel 10 such that data-writing discharge is generated in the scanning period Ts in the second and fourth sub-fields SF2 and SF4 both having no priming period, only when data-writing discharge is generated in the scanning period Ts in the first and third sub-fields SF1 and SF3 arranged immediately before the second and fourth sub-fields SF2 and SF4, respectively. This makes it possible to prevent an increase in a data voltage which is caused when data-writing discharge is generated in a sub-field having no priming period. Accordingly, it is possible to reduce a priming brightness without an increase in a data voltage, and hence, also possible to prevent reduction in a contrast between a display area and a non-display area in a plasma display panel.

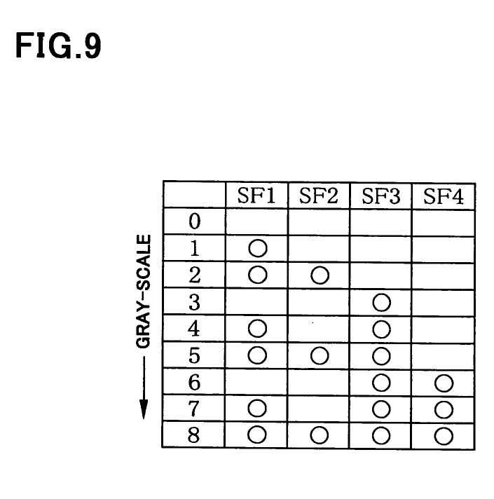

FIG. 9 illustrates an example of gray-scale code to accomplish nine gray-scales by virtue of a combination of the above-mentioned first to fourth sub-fields SF1 to SF4.

For instance, if a gray-scale of two (2) is to be accomplished, the first and second sub-fields SF1 and SF2 are combined to each other. For instance, if a gray-scale of six (6) is to be accomplished, the third sub-field SF3 having a gray-scale of 3 and the fourth sub-field SF4 having a gray-scale of 3 are combined to one another. If a gray-scale of eight (8) is to be accomplished, the first to fourth sub-fields SF1 to SF4 are combined to one another. When the second and fourth sub-fields SF2 and SF4 are selected, the first and third sub-fields SF1 and SF3 arranged immediately before the second and fourth sub-fields SF2 and SF4 are always selected.

As having been explained so far, in a process of driving the plasma display panel 10, one field F is comprised of a first sub-field SF1, a second sub-field SF2, a third sub-field SF3 and a fourth sub-field SF4, and the first and third sub-fields SF1 and SF3 are designed to have a priming period Tp (first period), but the second and fourth sub-fields SF2 and SF4 are designed to have no priming period Tp. Data-writing discharge is generated in the second and fourth sub-fields SF2 and SF4 both having no priming period, only when data-writing discharge is generated in the first and third sub-fields SF1 and SF3 arranged immediately before the second and fourth sub-fields SF2 and SF4. Thus, it is possible to prevent an increase in a data voltage which is caused when data-writing discharge is generated in a sub-field having no priming period. Accordingly, it is possible to reduce a priming brightness without an increase in a data voltage, and hence, also possible to prevent reduction in a contrast between a display area and a non-display area in a plasma display panel.

### Second Embodiment

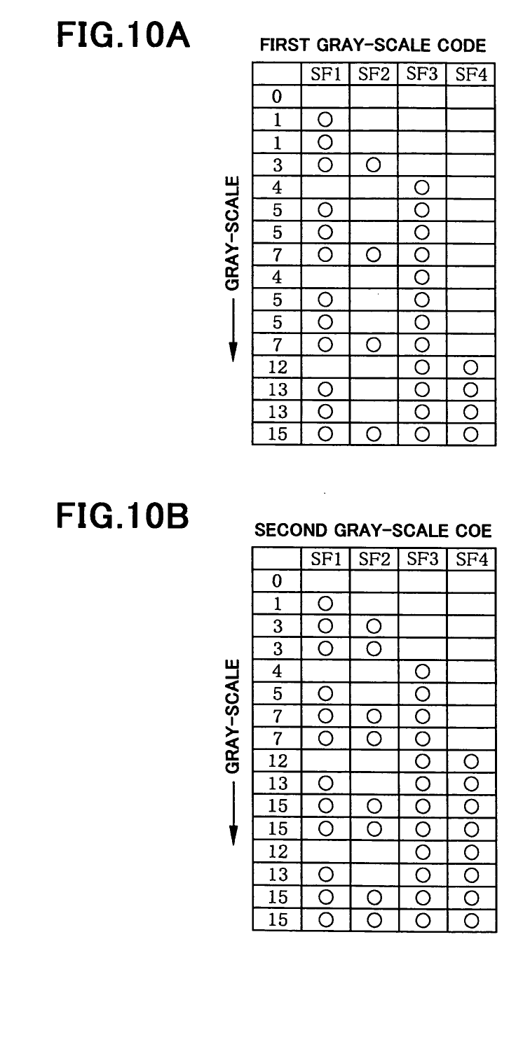

Each of FIGS. 10A and 10B shows an example of gray-scale code used in a process of driving a plasma display panel, in accordance with the second embodiment of the present invention.

The second embodiment is different from the above-mentioned first embodiment in that two gray-scale codes having different combination of sub-fields are used alternately for each of fields.

Specifically, in the second embodiment, one field F is comprised of a first sub-field SF1, a second sub-field SF2, a third sub-field SF3 and a fourth sub-field SF4, and the first and third sub-fields SF1 and SF3 are designed to have a priming period Tp, but the second and fourth sub-fields SF2 and SF4 are designed to have no priming period Tp. Data-writing discharge is generated in the second and fourth sub-fields SF2 and SF4 both having no priming period, only when data-writing discharge is generated in the first and third sub-fields SF1 and SF3 arranged immediately before the second and fourth sub-fields SF2 and SF4. In addition, a first gray-scale code illustrated in FIG. 10A and a second gray-scale code illustrated in FIG. 10B are selected alternately per a field.

If the gray-scale code illustrated in FIG. 9 is used, the number of gray-scales accomplished by a combination of two sub-fields is three, which is smaller than the gray-scale number of four accomplished in a conventional plasma display panel. Thus, the greater number of sub-fields would be necessary to be used in order to accomplish the gray-scale number of four, resulting in that a period of time for driving a plasma display panel is shortened, and hence, a brightness is reduced.

Since the first and second gray-scale codes having different combination of sub-fields are alternately selected per a field in the second embodiment, it would be possible to accomplish the same gray-scale number as that of a conventional plasma display panel by combining the same number of sub-fields as that of a conventional plasma display panel, to one another. Thus, a viewer can see images having an averaged brightness.

The second embodiment provides almost the same advantages as those of the first embodiment. In addition, the second embodiment can accomplish the target gray-scale number without an increase in the number of sub-fields to be combined to one another.

### Third Embodiment

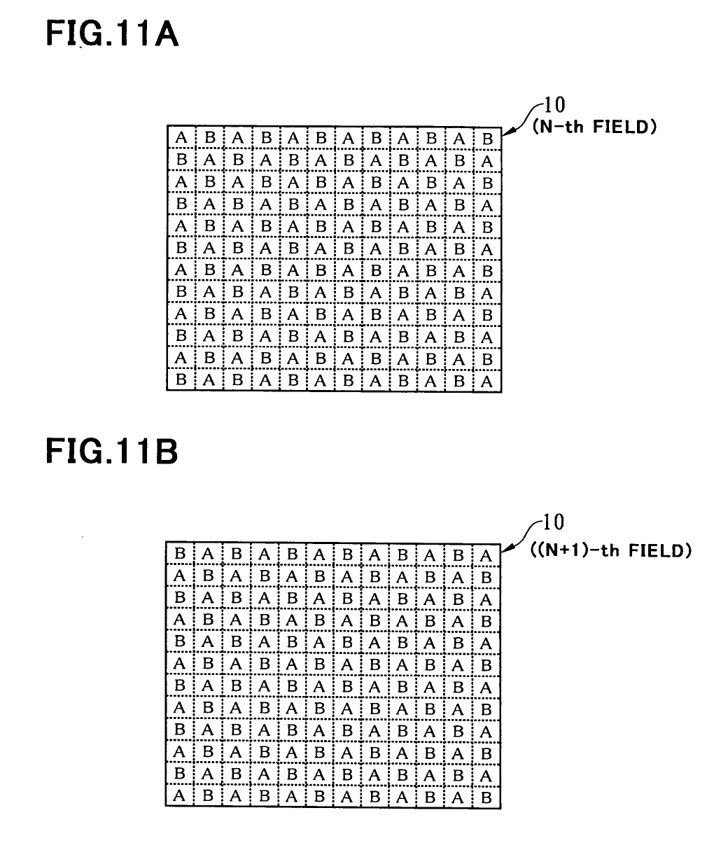

Each of FIGS. 11A and 11B shows an example of gray-scale code used in a process of driving a plasma display panel, in accordance with the third embodiment of the present invention.

The third embodiment is different from the above-mentioned first embodiment in that two gray-scale codes having different combination of sub-fields are used alternately for each of pixels defining an image in a field.

Specifically, in the third embodiment, one field F is comprised of a first sub-field SF1, a second sub-field SF2, a third sub-field SF3 and a fourth sub-field SF4, and the first and third sub-fields SF1 and SF3 are designed to have a priming period Tp, but the second and fourth sub-fields SF2 and SF4 are designed to have no priming period Tp. Data-writing discharge is generated in the second and fourth sub-fields SF2 and SF4 both having no priming period, only when data-writing discharge is generated in the first and third sub-fields SF1 and SF3 arranged immediately before the second and fourth sub-fields SF2 and SF4. In addition, a first gray-scale code illustrated in FIG. 11A and a second gray-scale code illustrated in FIG. 11B are selected alternately per a pixel defining an image in a field.

The first gray-scale code illustrated in FIG. 11A is used for each of pixels defining an image in a N-th field, and the second gray-scale code illustrated in FIG. 11B is used for each of pixels defining an image in a (N+1)-th field, wherein N is an integer equal to or greater than one.

If a gray-scale code is changed for each of fields like the second embodiment, a brightness of images is varied at a frequency equal to a half of a field frequency. As a result, some images may be recognized as flicker.

In accordance with the third embodiment, the first and second gray-scale codes having different combination of sub-fields are used alternately per each of pixels defining an image in a field. Thus, a viewer can see image having a spatially averaged brightness, and hence, does not recognize flickers.

It is possible to accomplish the same gray-scale number as that of a conventional plasma display panel by combining the same number of sub-fields as that of a conventional plasma display panel, to one another.

The third embodiment provides almost the same advantages as those of the first embodiment. In addition, since the third embodiment uses different gray-scale codes for each of pixels defining an image, a viewer does no longer observe flickers.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

For instance, a field in the above-mentioned first to third embodiments is designed to be comprised of four sub-fields, specifically, a sub-field having a priming period, a sub-field having no priming period, a sub-field having a priming period, and a sub-field having no priming period arranged in this order. As an alternative, a field may be designed to be comprised of a sub-field having a priming period and three or more sub-fields having no priming period.

The entire disclosure of Japanese Patent Application No. 2003-277932 filed on Jul. 22, 2003 including specification, claims, drawings and summary is incorporated herein by reference in its entirety.

1. A method of driving a plasma display panel displaying images in fields each comprised of at least one first-type sub-field having a priming period and at least one second-type sub-field having no priming period,
wherein data-writing discharge in said second-type sub-field is generated only when data-writing discharge in said first-type sub-field arranged immediately before said second sub-filed is generated.

2. The method as set forth in claim 1, wherein two gray-scale codes having different combinations of said first and second-type sub-fields are switched alternately for every field.

3. The method as set forth in claim 1, wherein two gray-scale codes having different combinations of said first and second-type sub-fields are switched alternately for every pixel defining image of a field.

4. The method as set forth in claim 1, wherein each of said fields is comprised of said first, second, first and second-type sub-fields arranged in this order.

5. The method as set forth in claim 1, wherein each of said fields is comprised of one first-type sub-field and at least three second-type sub-fields.

6. A plasma display panel displaying images in fields each comprised of at least one first-type sub-field having a priming period and at least one second-type sub-field having no priming period, comprising:
a first substrate;
a second substrate facing said first substrate;
a pair of row electrodes arranged on said first substrate in parallel with each other;
a column electrode arranged on said second substrate perpendicularly to said row electrodes;
cells formed at intersections of said row electrodes and said column electrode; and
a controller which generates data-writing discharge in said second-type sub-field only when data-writing discharge in said first-type sub-field arranged immediately before said second sub-filed is generated.

7. The plasma display panel as set forth in claim 6, wherein said controller alternately switches two gray-scale codes having different combinations of said first and second-type sub-fields for every field.

8. The plasma display panel as set forth in claim 6, wherein said controller alternately switches two gray-scale codes having different combinations of said first and second-type sub-fields for every pixel defining image of a field.

9. The plasma display panel as set forth in claim 6, wherein said controller defines each of said fields to be comprised of said first, second, first and second-type sub-fields arranged in this order.

10. The plasma display panel as set forth in claim 6, wherein said controller defines each of said fields to be comprised of one first-type sub-field and at least three second-type sub-fields.

11. A plasma display unit comprising:
a plasma display panel displaying images in fields each comprised of at least one first-type sub-field having a priming period and at least one second-type sub-field having no priming period; and
drivers for driving said plasma display panel,
said plasma display panel comprising:
a first substrate;
a second substrate facing said first substrate;
a pair of row electrodes arranged on said first substrate in parallel with each other;
a column electrode arranged on said second substrate perpendicularly to said row electrodes;
cells formed at intersections of said row electrodes and said column electrode; and
a controller which generates data-writing discharge in said second-type sub-field only when data-writing discharge in said first-type sub-field arranged immediately before said second sub-filed is generated.

12. The plasma display unit as set forth in claim 11, wherein said controller alternately switches two gray-scale codes having different combinations of said first and second-type sub-fields for every field.

13. The plasma display unit as set forth in claim 11, wherein said controller alternately switches two gray-scale codes having different combinations of said first and second-type sub-fields for every pixel defining image of a field.

14. The plasma display unit as set forth in claim 11, wherein said controller defines each of said fields to be comprised of said first, second, first and second-type sub-fields arranged in this order.

15. The plasma display unit as set forth in claim 11, wherein said controller defines each of said fields to be comprised of one first-type sub-field and at least three second-type sub-fields.

16. A program for causing a computer to carry out a method of driving a plasma display panel displaying images in fields each comprised of at least one first-type sub-field having a priming period and at least one second-type sub-field having no priming period, wherein steps executed by said computer in accordance with said program include generating data-writing discharge in said second-type sub-field only when data-writing discharge in said first-type sub-field arranged immediately before said second sub-filed is generated.

17. The program as set forth in claim 16, wherein said steps further include alternately switching two gray-scale codes having different combinations of said first and second-type sub-fields for every field.

18. The program as set forth in claim 16, wherein said steps further include alternately switching two gray-scale codes having different combinations of said first and second-type sub-fields for every pixel defining image of a field.

19. The program as set forth in claim 16, wherein said steps further include defining each of said fields to be comprised of said first, second, first and second-type sub-fields arranged in this order.

20. The program as set forth in claim 16, wherein said steps further include defining each of said fields to be comprised of one first-type sub-field and at least three second-type sub-fields.
